(19) United States
(12) Patent Application Publication
(10) Pub. No.: US 2026/0225055 A1
(43) Pub. Date: Aug. 6, 2026

(54) FLOW RESTRICTORS FOR INTRODUCING ACCELERATORS INTO SEALANT MIXING CARTRIDGES

(71) Applicant: PRC-Desoto International, Inc., Sylmar, CA (US)

(72) Inventors: Paul Kuchinski, Valley Village, CA (US); Oscar Santillan, Camarillo, CA (US)

(73) Assignee: PRC-Desoto International, Inc., Sylmar, CA (US)

(21) Appl. No.: 19/149,652

(22) PCT Filed: Jan. 27, 2023
(86) PCT No.: PCT/US2023/061457

§ 371 Date: Jul. 21, 2025

(51) Int. Cl. B01F 31/40; B01F 27/112; B01F 33/501; B01F 35/71; B01F 35/75; B01F 101/36

(52) U.S. Cl. CPC B01F 31/40; B01F 27/112; B01F 33/50112; B01F 35/7162; B01F 35/7174; B01F 35/754251; B01F 2101/36

(57) ABSTRACT

A sealant cartridge mixing assembly is disclosed, including sealant cartridge for containing a sealant formulation, a hollow dasher rod for receiving a liquid accelerator therein and engaging a sealant mixing impeller located inside the sealant cartridge, and a flow restrictor located at an accelerator dispensing end of the dasher rod. The flow restrictor includes an outer wall, a top surface, and a central delivery tube including a delivery tube outlet opening in the top surface. The central delivery tube provides communication between the hollow dasher rod and an interior of the sealant cartridge. A method of introducing liquid accelerator into a sealant formulation a mixing cartridge comprising: inserting a dasher rod containing the liquid accelerator into an interior of the sealant mixing cartridge containing the sealant formulation; engaging a tip of the dasher rod with an impeller located in the interior of the sealant mixing cartridge; reciprocally moving the dasher rod and impeller in relation to the sealant mixing cartridge in an axial direction, and rotating the dasher rod and impeller in relation to the sealant mixing cartridge, to thereby mix the sealant formulation; and introducing the liquid accelerator from the dasher rod into the interior of the container through a flow restrictor during the mixing of the sealant formulation, wherein the flow restrictor comprises: an outer wall; a top surface; and a central delivery tube extending in an axial direction of the flow restrictor comprising a delivery tube outlet opening in the top surface, wherein the central delivery tube provides fluid flow communication between the hollow dasher rod and an interior of the sealant cartridge.

### FIELD

Flow restrictors for introducing accelerators into sealant mixing cartridges are disclosed.

### BACKGROUND

Conventional adhesive and sealant mixers, such as those utilized in the aerospace industry, are used to mix separate components together in a cartridge. The cartridges are mounted on a reciprocating platform, and a rotating dasher rod with an impeller is forced through the inside of the cartridge to mix the adhesive or sealant components together. A liquid catalyst or accelerator may be introduced into the mixing zone of the cartridge through the dasher rod by means of an injection rod that pushes the accelerator catalyst out of the hollow dasher rod as it travels through the cartridge. However, uneven injection of the accelerator may occur, causing uneven curing of the adhesive or sealant and hardness problems.

### SUMMARY

Disclosed herein is a sealant cartridge mixing assembly. The sealant cartridge mixing assembly comprises a sealant cartridge structured and arranged to contain a sealant formulation, a hollow dasher rod structured and arranged to receive a liquid accelerator therein, and to engage a sealant mixing impeller located inside the sealant cartridge, and a flow restrictor located at an accelerator dispensing end of the dasher rod. The flow restrictor comprises an outer wall, a top surface, and a central delivery tube extending in an axial direction of the flow restrictor comprising a delivery tube outlet opening in the top surface. The central delivery tube provides fluid flow communication between the hollow dasher rod and an interior of the sealant cartridge.

Also disclosed herein is a dasher rod for a sealant cartridge mixing assembly. The dasher rod for a sealant cartridge mixing assembly comprises a hollow cylindrical body structured and arranged to contain a liquid accelerator therein, and to engage a sealant mixing impeller, and a flow restrictor installed at an accelerator dispensing end of the hollow cylindrical body. The flow restrictor comprises an outer wall, a top surface, and a central delivery tube extending in an axial direction of the flow restrictor comprising a delivery tube outlet opening in the top surface. The central delivery tube provides fluid flow communication from an interior of the hollow cylindrical body through the delivery tube outlet opening.

Further disclosed herein is a method of introducing liquid accelerator into a sealant formulation in a mixing cartridge. The method comprises inserting a dasher rod containing the liquid accelerator into an interior of the sealant mixing cartridge, engaging a tip of the dasher rod with an impeller located in the interior of the sealant mixing cartridge, reciprocally moving the dasher rod and impeller in relation to the sealant mixing cartridge in an axial direction, and rotating the dasher rod and impeller in relation to the sealant mixing cartridge, to thereby mix the sealant formulation. The accelerator is introduced from the dasher rod into the interior of the sealant mixing container through a flow restrictor during the mixing of the sealant formulation. The flow restrictor comprises an outer wall, a top surface, and a central delivery tube extending in an axial direction of the flow restrictor comprising a delivery tube outlet opening in the top surface through which the liquid accelerator flows from the hollow dasher rod into the interior of the sealant cartridge.

### BRIEF DESCRIPTION OF THE DRAWINGS

FIGS. 1-3 are side sectional views of a sealant cartridge mixing assembly with a dasher rod and impeller positioned at varying stroke positions within a sealant cartridge.

FIG. 4 is a side view of the dasher rod shown in FIGS. 1-3.

FIG. 5 is an enlarged view of the upper portion of the dasher rod shown in FIG. 4.

FIG. 6 is a side sectional view taken through section 6-6 of FIG. 5, showing a flow restrictor installed at the upper end of the dasher rod and an end cap covering the top of the dasher rod.

FIG. 7 is a side sectional view similar to FIG. 6, with the end cap removed.

FIG. 8 is an isometric view of a flow restrictor for controlling the dispensing rate of accelerator from the dasher rod during sealant mixing operations.

FIG. 9 is a side view of the flow restrictor of FIG. 8.

FIG. 10 is a side sectional view taken through section 10-10 of FIG. 9.

FIG. 11 is a top view of the flow restrictor.

FIG. 12 is a bottom view of the flow restrictor.

FIG. 13 is an isometric view of the end cap.

FIG. 14 is a side view of the end cap of FIG. 13.

FIG. 15 is a side sectional view taken through section 15-15 of FIG. 14.

### DETAILED DESCRIPTION

FIGS. 1-3 illustrate a sealant cartridge mixing assembly 5 in which an accelerator is introduced into the interior of a cartridge through a reciprocating dasher rod having an impeller mounted thereon. The sealant cartridge mixing assembly 5 includes a sealant cartridge 10 and a dasher rod 20. The sealant cartridge assembly 5 may be used to mix one or more components of a sealant formulation that is initially introduced into the sealant cartridge 10 with a curing agent and/or an accelerator that is initially contained in the dasher rod 20. As used herein, the term “sealant” includes both sealant and adhesive formulations. As used herein, “accelerator” means a substance that increases the rate or decreases the activation energy of a chemical reaction. An accelerator may be either a “catalyst,” that is, without undergoing any permanent chemical change, or may be a “curing agent” which is reactive, that is, capable of chemical reactions and includes any level of reaction from partial to complete reaction of a reactant.

The sealant cartridge 10 includes a generally cylindrical sidewall 12 and a domed lower end 14 with a discharge opening 15 through which the cartridge 10 may be filled with sealant, and through which the sealant may be subsequently discharged from the cartridge 10.

The discharge opening 15 may be interiorly threaded 16 for connection to a sealant dispensing tip (not shown) used to dispense the mixed sealant. The sealant cartridge 10 includes an open upper end 17 through which a plunger 18 may be inserted in the sealant cartridge 10 and initially positioned at or near the domed lower end 14 prior to filling of the sealant cartridge 10 with sealant. The volume inside the cartridge 10 between the domed lower end 14 and plunger 18 defines a sealant volume inside the cartridge 10. As more fully described below, the sealant compositions may comprise formulations known to those skilled in the art.

The dasher rod 20 is inserted in the sealant cartridge 10 through the discharge opening 15 of the sealant cartridge 10, and engages an impeller 26, which may be initially provided inside the sealant cartridge 10 and may remain in the sealant cartridge 10 after the mixing operation is completed. The impeller 26 includes a central annular hub 27 with multiple mixing arms 28 extending radially outward therefrom. The impeller shown in FIGS. 1-3 includes three mixing arms. However, any other suitable number of mixing arms may be used such as two, four, or more.

The sealant cartridge assembly 5 may be used to mix one or more components of sealant formulations that are initially introduced into the sealant cartridge 10 with an accelerator that is initially contained in the dasher rod 20, as more fully described below. Mixing of the components in the sealant cartridge 10 is achieved by stroking the rotating dasher rod 20 and impeller 26 mounted thereon from one end of the cartridge 10 to the other. When mixing is completed, the dasher rod 20 may be disengaged from the impeller 26, and the dasher rod 20 may be removed through the discharge opening 15 of the sealant cartridge 10.

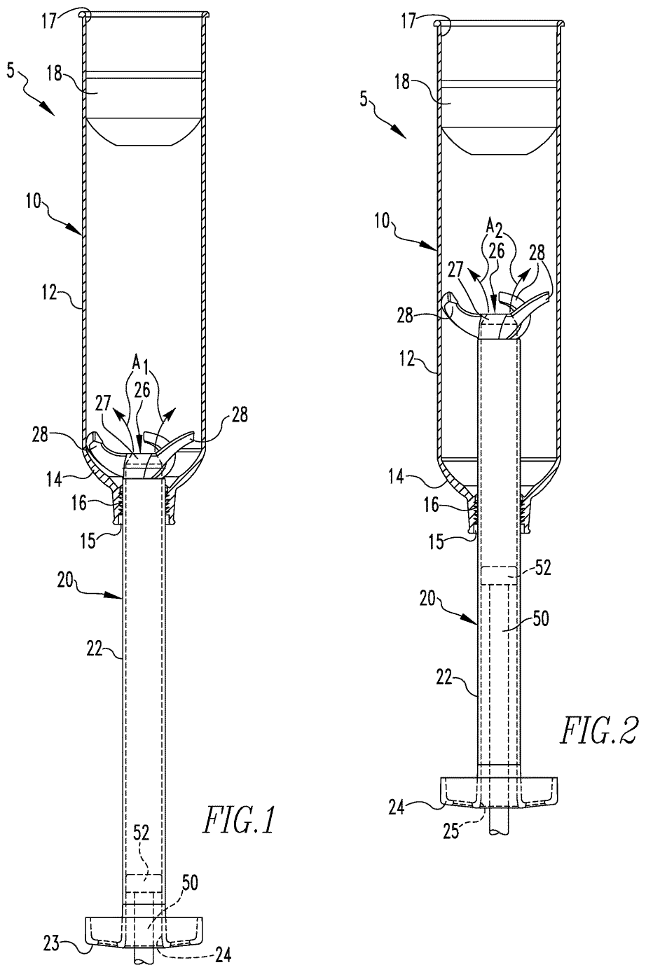

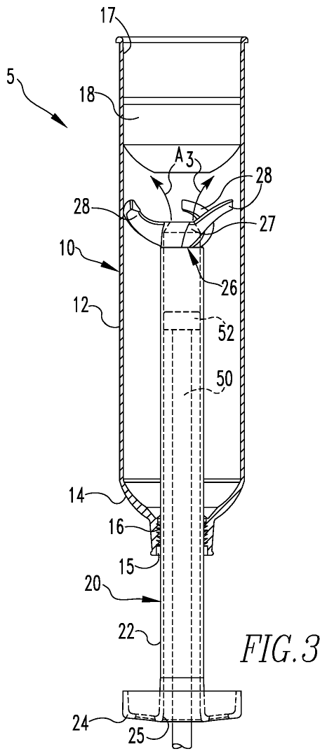

The mixing impeller 26 may be forced through the sealant formulation contained in the sealant cartridge 10 through the relative vertical movement of the sealant cartridge 10 in relation to the vertically stationary mixing impeller 26 and dasher rod 20. FIG. 1 shows the impeller 26 and dasher rod 20 at a lower stroke position in the sealant cartridge 10. FIG. 2 shows the impeller 26 and dasher rod 20 at a mid-stroke position. FIG. 3 shows the impeller 26 and dasher rod 20 at an upper-stroke position. The stroke distance inside the sealant cartridge 10 is defined by the distance the impeller 26 moves between the lower domed end 14 and the upper plunger 18. Typical stroke distances may range from 2 to 8 inches, for example, from 3 to 6 inches, depending on the size of a particular cartridge.

As further shown in FIGS. 1-5, the dasher rod 20 includes a hollow cylindrical body 22 with a spindle attachment disk 23 located at its bottom end. A central opening 24 through the spindle attachment disk 23 communicates with the interior of the cylindrical body 22. As shown in FIGS. 4-7, the dasher rod 20 includes an upper threaded tip 25 with an end cap 40 that is removably installed at the top of the dasher rod 20 partially surrounding the threaded tip 25. After the end cap 40 is removed, the dasher rod 20 is mounted through the discharge opening 15 and the impeller 26 is threaded onto the threaded tip 25.

As further shown in FIGS. 1-3, a catalyst injection rod 50 with an injection head 52 is slidable through the center opening inside the hollow cylindrical body 22 of the dasher rod 20 containing liquid accelerator. As the injection rod 50 and injection head 52 move upward in the cylindrical body 22 from the lower position shown in FIG. 1, to the mid position shown in FIG. 2, and to the upper position shown in FIG. 3, the accelerator is forced from the hollow cylindrical body 22 through a flow restrictor 30 into the interior of the sealant cartridge 10.

As shown in FIGS. 1-3, as the dasher rod 20 and impeller 26 move in relation to the sealant cartridge 10 from the lower position shown in FIG. 1, to the mid position shown in FIG. 2, and to the upper position shown in FIG. 3, accelerator initially contained in the hollow body 22 is dispensed from the upper tip of the dasher rod 20 into the sealant cartridge 10. The flow of liquid accelerator is labeled as A1 in FIG. 1, A2 in FIG. 2, and A3 in FIG. 3. As more fully described below, through the use of the flow restrictor 30, the accelerator flow rates of A1, A2 and A3 as the dasher rod 20 and impeller 26 are stroked through the cartridge 10 are controlled to be substantially uniform, thereby reducing or eliminating uneven injection.

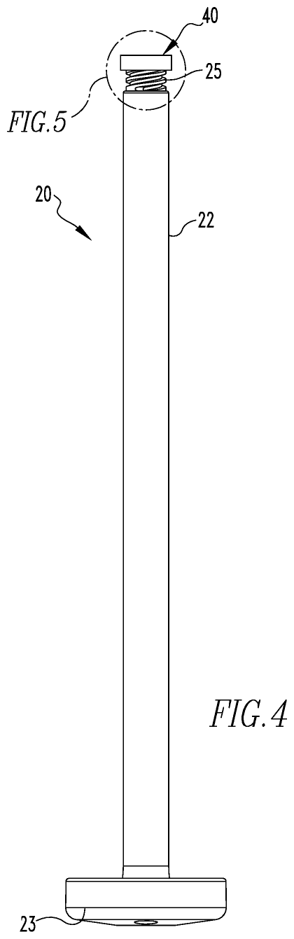

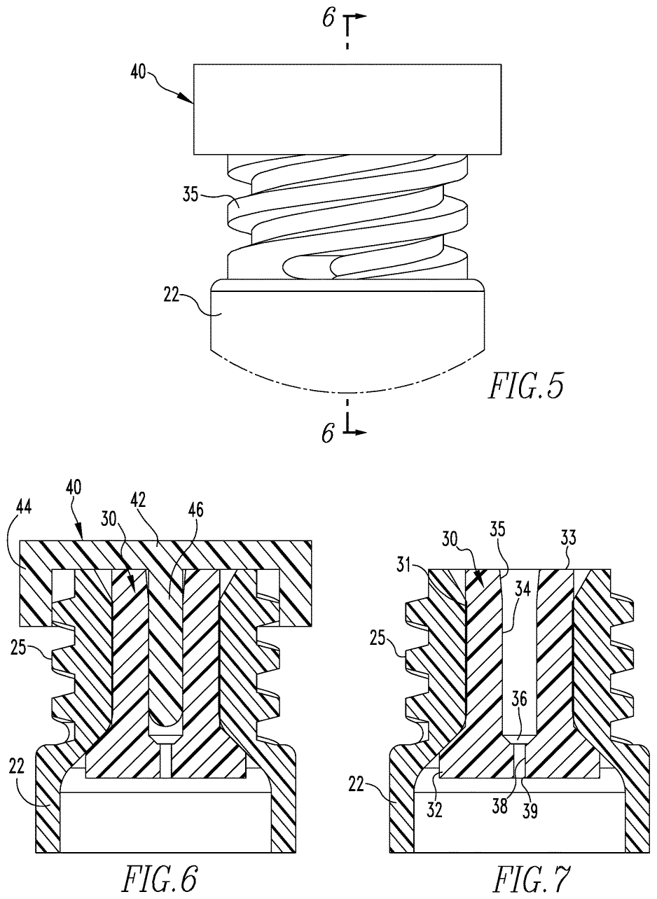

As shown in FIGS. 6 and 7, the flow restrictor 30 is installed at the top of the hollow cylindrical body 22 at the upper end of the dasher rod 20. In FIG. 6, the cap 40 is initially secured to the top of the dasher rod 20 to prevent accelerator from escaping the cylindrical body 22 prior to a mixing operation. As shown in FIG. 7, the end cap 40 may be removed from the top of the dasher rod 20 to permit flow of accelerator from the cylindrical body 22 of the dasher rod 20. The flow restrictor 30 may be maintained in a stationary or fixed position in the accelerator dispensing end of the dasher rod 20 prior to and during the mixing operation.

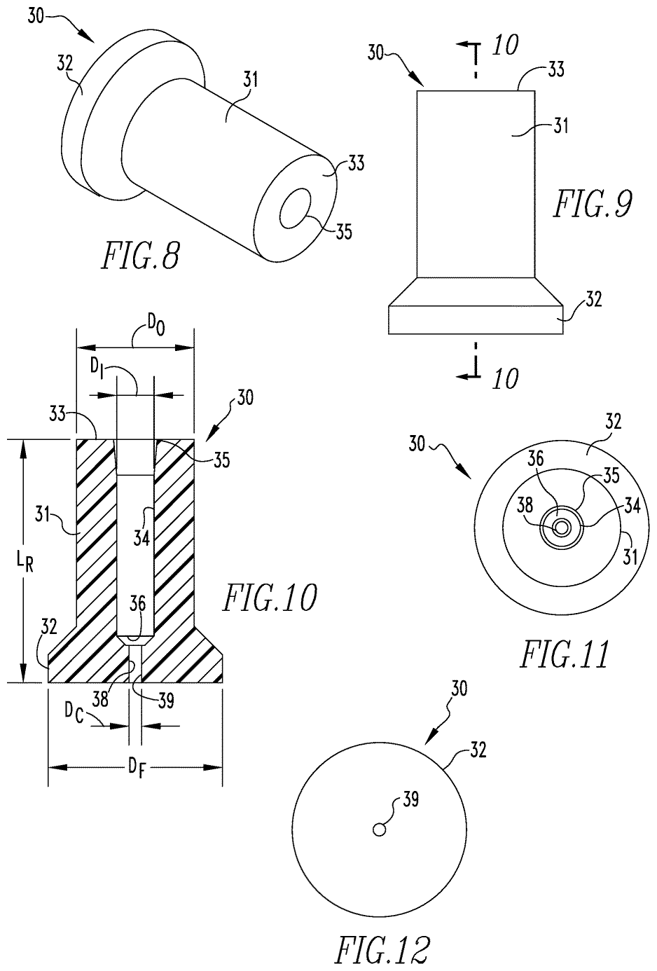

Details of the flow restrictor 30 are shown in FIGS. 8-12. The flow restrictor 30 includes a cylindrical outer wall 31 that extends downward to a base flange 32. The cylindrical outer wall 31 terminates at a top surface 33. A cylindrical central delivery tube 34 extends axially through the flow restrictor 30 to the top surface 33. A flared delivery tube outlet opening 35 is provided at the top of the central delivery tube 34. A lower end of the central delivery tube 34 extends through a generally conical transition region 36, which communicates with a cylindrical flow constriction tube 38 having a central longitudinal axis corresponding to a central longitudinal axis of the central delivery tube 34. The flow constriction tube 38 terminates at a lower constriction tube inlet opening 39 at the base flange 32. As shown in FIGS. 8-12, the outer wall 31 of the flow restrictor may be solid, i.e., a continuous piece of material that tdoes not have openings that would allow the accelerator to flow radially through the outer wall.

As shown most clearly in FIG. 10, the flow restrictor 30 has selected dimensions that facilitate desired accelerator flow patterns with uniform flow rates such as the flow patterns A1, A2 and A3 illustrated in FIGS. 1-3. The flow restrictor 30 has a length L_{R} measured along its axial direction. The outer wall 31 of the flow restrictor 30 has an outer diameter D_{O}. The central delivery tube 34 extending through the flow restrictor 30 has an inner diameter D_{I}. The flow constriction tube 38 has a constricted diameter D_{C}. The base flange 32 has an outer flange diameter D_{F}.

The length L_{R} of the flow restrictor 30 is typically greater than 0.10 inch, for example, greater than 0.20 inch, or greater than 0.30 inch. The length L_{R} is typically less than 1.0 inch, for example, less than 0.80 inch, or less than 0.50 inch. The length L_{R} typically ranges from 0.10 to 1.0 inch, for example, from 0.20 to 0.80 inch, or from 0.30 to 0.50 inch.

The outer diameter D_{O} is typically greater than 0.1 inch, for example, greater than 0.15 inch, or greater than 0.18 inch. The outer diameter D_{O} is typically less than 0.3 inch, for example, less than 0.25 inch, or less than 0.22 inch. The outer diameter D_{O} typically ranges from 0.1 to 0.3 inch, or from 0.15 to 0.25 inch, or from 0.18 to 0.22 inch.

The inner diameter D_{I} is typically greater than 0.02 inch, for example, greater than 0.04 inch, or greater than 0.05 inch. The inner diameter D_{I} is typically less than 0.10 inch, for example, less than 0.08 inch, or less than 0.07 inch. The inner diameter D_{I} typically ranges from 0.02 to 0.10 inch, or from 0.04 to 0.08 inch, or from 0.05 to 0.07 inch.

The constricted diameter D_{C} is typically greater than 0.005 inch, for example, greater than 0.02 inch, or greater than 0.028 inch. The constricted diameter D_{C} is typically less than 0.05 inch, for example, less than 0.04 inch, or less than 0.032 inch. The constricted diameter D_{C} typically ranges from 0.005 to 0.05 inch, or from 0.02 to 0.04 inch, or from 0.028 to 0.032 inch.

The outer diameter D_{O} and the inner diameter D_{I} may have an outer to inner diameter D_{O}:D_{I} ratio greater than 1:1, for example, greater than 1.1:1, or greater than 1.5:1, or greater than 2:1. The D_{O}:D_{I} ratio may be less than 10:1, or less than 7.1 or less than 5:1. The outer diameter D_{O} and the inner diameter D_{I} may have a typical D_{O}:D_{I} ratio of from 10:1 to 1:1, for example, from 10:1 to 1.5:1, or from 7:1 to 1.5:1, or from 5:1 to 2:1.

The outer diameter D_{O} and the constricted diameter D_{C} may have an outer to constricted diameter D_{O}:D_{C} ratio greater than 1:1, for example, greater than 2:1, or greater than 3:1, or greater than 5:1. The D_{O}:D_{C} ratio may be less than 20:1, or less than 12.1 or less than 10:1. The outer diameter Dₒ and the constricted diameter D_{C} may have a typical D_{O}:D_{C} ratio of from 20:1 to 1:1, for example, from 12:1 to 3:1, or from 10:1 to 5:1.

The inner diameter D_{I} and the constricted diameter D_{C} may have an inner to constricted diameter D_{I}:D_{C} ratio greater than 1:1, for example, greater than 1.1:1, or greater than 1.2:1, or greater than 1.5:1. The D_{I}:D_{C} ratio may be less than 5:1, or less than 4.1 or less than 3:1. The inner diameter D_{I} and the constricted diameter D_{C} may have a typical D_{I}:D_{C} ratio of from 5:1 to 1:1, for example, from 5:1 to 1.2:1, or from 4:1 to 1.2:1, or from 3:1 to 1.5:1.

The flange diameter D_{F} is typically greater than 0.10 inch, for example, greater than 0.20 inch, or greater than 0.25 inch. The diameter of flange D_{F} is typically less than 0.50 inch, for example, less than 0.40 inch, or less than 0.30 inch. The diameter of flange D_{F} typically ranges from 0.10 to 0.50 inch, for example, from 0.20 to 0.40 inch, or from 0.25 to 0.30 inch.

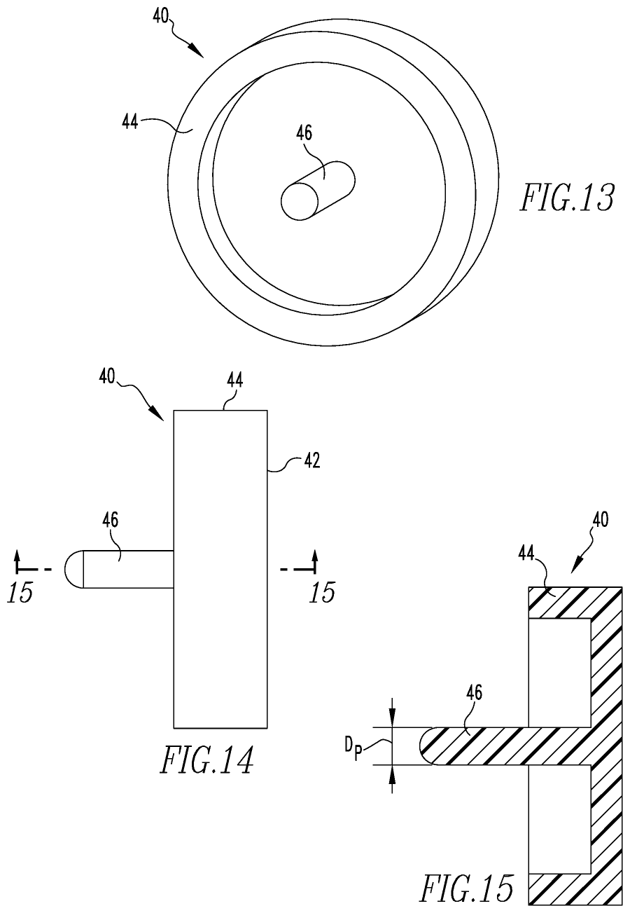

As shown in FIGS. 13-15, the dasher rod endcap 40 includes a top disk 42 and annular sidewall 44. A central pin 46 extends inwardly from the interior surface of the top disk 42. As shown in FIG. 15, the central pin 46 has an outer diameter D_{P}. The diameter of the pin D_{P} is typically greater than 0.02 inch, for example, greater than 0.04 inch, or greater than 0.05 inch. The diameter of pin D_{P} is typically less than 0.10 inch, for example, less than 0.08 inch, or less than 0.07 inch. The diameter of pin D_{P} typically ranges from 0.02 to 0.10 inch, or from 0.04 to 0.08 inch, or from 0.05 to 0.07 inch. The outer diameter D_{P} of the central pin 46 and the inner diameter D_{I} of the central delivery tube 34 of the flow restrictor 30 may be selected in order to provide a desired fit that prevents flow of the catalyst through the central delivery tube 34 prior to use, and allows the central pin 46 and end cap 40 to be removed from the flow restrictor 30 to allow accelerator flow during mixing operations. For example, the outer diameter D_{I} of the pin 46 may be the same as, or slightly larger than, the inner diameter D_{I} of the central delivery tube 34.

The sealant formulations initially contained in the sealant cartridge 10 may comprise a two-component (“2K”) composition. As used herein, a “two-component composition” (or “2K composition”) refers to an adhesive or sealant composition in which at least a portion of the reactive components readily react and cure without activation from an external energy source, such as at ambient or slightly thermal conditions, when mixed with an accelerator in the form of a catalyst component. One skilled in the art understands that the two components of the adhesive or sealant composition are stored separately from each other and mixed just prior to application of the composition.

The first component of the 2K composition may comprise one or more epoxy-containing compounds, such as epoxies, polysulfides, polythioethers and the like. The sealant composition may further comprise a second component that chemically reacts with the first component, such as manganese dioxide, dichromate polysulfide, epoxy and the like. As used herein, the term “cure”, “cured” or similar terms, as used in connection with the adhesive composition described herein, means that at least a portion of the components that form the adhesive or sealant composition are crosslinked to form an adhesive layer or bond.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth broad scope are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, unless indicated otherwise, a plural term can encompass its singular counterpart and vice versa, unless indicated otherwise. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect basic and novel characteristic(s)”.

As used herein, unless indicated otherwise, the term “substantially free” means that a particular element or material is not purposefully added to a mixture or composition and is present only as an impurity or in a trace amount.

As used herein, the terms “on,” “onto,” “applied on,” “applied onto,” “formed on,” “deposited on,” “deposited onto,” mean formed, overlaid, deposited, or provided on but not necessarily in contact with the surface. For example, an electrodepositable coating composition “deposited onto” a substrate does not preclude the presence of one or more other intervening coating layers of the same or different composition located between the electrodepositable coating composition and the substrate.

Whereas particular examples of this disclosure have been described above for purposes of illustration, it will be evident to those skilled in the art that numerous variations of the details of the present disclosure may be made without departing from what is defined in the appended claims.

1. A sealant cartridge mixing assembly comprising:
a sealant cartridge structured and arranged to contain a sealant formulation;
a hollow dasher rod structured and arranged to receive a liquid accelerator therein, and to engage a sealant mixing impeller located inside the sealant cartridge; and
a flow restrictor located at an accelerator dispensing end of the dasher rod, the flow restrictor comprising:
an outer wall;
a top surface; and
a central delivery tube extending in an axial direction of the flow restrictor comprising a delivery tube outlet opening in the top surface, wherein the central delivery tube provides fluid flow communication between the hollow dasher rod and an interior of the sealant cartridge.

2. The sealant cartridge mixing assembly of claim 1, wherein the central delivery tube has an outer diameter D_{O}, the central delivery tube has an inner diameter D_{I}, and a ratio of D_{O}:D_{I} is greater than 1.1:1.

3. The sealant cartridge mixing assembly of claim 2, wherein the ratio of D_{O}:D_{I} is from 10:1 to 1.5:1.

4. The sealant cartridge mixing assembly of claim 1, wherein the central delivery tube is tapered radially outward at the delivery tube outlet opening.

5. The sealant cartridge mixing assembly of claim 1, wherein the flow restrictor comprises a flow constriction tube in fluid flow communication with the central delivery tube, wherein the flow constriction tube extends in the axial direction and comprises a constriction tube inlet opening in a bottom surface of the flow restrictor.

6. The sealant cartridge mixing assembly of claim 5, wherein the central delivery tube has an inner diameter D_{I}, the flow constriction tube has a constricted diameter D_{C}, and a ratio of D_{I}:D_{C} is greater than 1.1:1.

7. The sealant cartridge mixing assembly of claim 6, wherein the ratio of D_{I}:D_{C} is from 5:1 to 1.2:1.

8. The sealant cartridge mixing assembly of claim 6, wherein the central delivery tube has an outer diameter D_{O}, and a ratio of D_{O}:D_{C} is greater than 2:1.

9. The sealant cartridge mixing assembly of claim 8, wherein D_{O}:D_{C}is from 12:1 to 3:1.

10. The sealant cartridge mixing assembly of claim 1, further comprising a transition between the central delivery tube and the flow constriction tube.

11. The sealant cartridge mixing assembly of claim 10, wherein the transition is generally conical.

12. The sealant cartridge mixing assembly of claim 1, wherein the flow restrictor comprises a base flange having an outer diameter D_{F} greater than an outer diameter D_{O} of the outer wall.

13. The sealant cartridge mixing assembly of claim 1, wherein the top surface of the flow restrictor is substantially flush with a top surface of a threaded tip of the dasher rod.

14. The sealant cartridge mixing assembly of claim 1, further comprising an end cap removably attached to a top end of the dasher rod.

15. The sealant cartridge mixing assembly of claim 14, wherein the end cap comprises a central pin removably inserted in the central delivery tube of the flow restrictor.

16. The sealant cartridge mixing assembly of claim 14, wherein the cap is structured and arranged for removal from the top end of the dasher rod prior to delivery of the liquid accelerator from the hollow dasher rod into the sealant cartridge.

17. The sealant cartridge mixing assembly of claim 1, wherein the flow restrictor is retained in a fixed position in the accelerator dispensing end of the dasher rod.

18. The sealant cartridge mixing assembly of claim 1, wherein the outer wall of the flow restrictor comprises a continuous material with no openings extending radially through the outer wall.

19. A dasher rod for a sealant cartridge mixing assembly comprising:
a hollow cylindrical body structured and arranged to contain a liquid accelerator therein, and to engage a sealant mixing impeller; and
a flow restrictor installed at an accelerator dispensing end of the hollow cylindrical body, the flow restrictor comprising:
an outer wall;
a top surface; and
a central delivery tube extending in an axial direction of the flow restrictor comprising a delivery tube outlet opening in the top surface, wherein the central delivery tube provides fluid flow communication from an interior of the hollow cylindrical body through the delivery tube outlet opening.

20.-36. (canceled)

37. A method of introducing liquid accelerator into a sealant formulation in a mixing cartridge comprising:
inserting a dasher rod containing the liquid accelerator into an interior of the sealant mixing cartridge containing the sealant formulation;
engaging a tip of the dasher rod with an impeller located in the interior of the sealant mixing cartridge;
reciprocally moving the dasher rod and impeller in relation to the sealant mixing cartridge in an axial direction, and rotating the dasher rod and impeller in relation to the sealant mixing cartridge, to thereby mix the sealant formulation;
and introducing the liquid accelerator from the dasher rod into the interior of the sealant mixing container through a flow restrictor during the mixing of the sealant formulation, wherein the flow restrictor comprises:
an outer wall;
a top surface; and
a central delivery tube extending in an axial direction of the flow restrictor comprising a delivery tube outlet opening in the top surface through which the liquid accelerator flows from the hollow dasher rod into the interior of the sealant cartridge.
